(19) United States
(12) Patent Application Publication
(10) Pub. No.: US 2006/0031289 A1
(43) Pub. Date: Feb. 9, 2006

(54) System and method for automatically launching and accessing netwrok addresses and applications

(76) Inventor: Bettina Experton, Del Mar, CA (US)

Correspondence Address: Jeffrey Pearch, 34825 Sultan-Startup Road, Sultan, WA, 98294, US

(21) Appl. No.: 10/532,781

(22) PCT Filed: Oct. 24, 2003
(86) PCT No.: PCT/US03/34012

§ 371 Date: Apr. 25, 2005

Related U.S. Application Data
(60) Provisional application No. 60/421,622, filed on Oct. 25, 2002.

(51) Int. Cl. G06F 15/16

(52) U.S. Cl. 709/204

(57) ABSTRACT

A system and method are provided for automatically launching one or more computer-executable processes (such as network browsers and other applications) simultaneously while requiring minimal input from or actions by the user. The system and method operate securely and privately, and provide the capability to automatically initiate the processes such that they access specific user data files or web addresses associated with each respective process, even when such access requires input of authorization or access information such as passwords.

### PRIORITY

This is an International Patent Application submitted under the Patent Cooperation Treaty (PCT). This International Application claims priority of United States Provisional Patent Application No. 60/421,622, filed 25 Oct. 2002, which is incorporated herein by reference.

### TECHNICAL FIELD

The invention relates to the automatic launching of network addresses and applications. More particularly, the invention relates to a system and method for automatically launching one or more application programs and/or one or more network addresses and automatically logging in to websites that require user authentication data prior to gaining access to certain data or web pages.

### BACKGROUND OF THE INVENTION

The use of computing devices, the Internet and the World Wide Web has increased dramatically in recent years. As a consequence, users-often have accounts with and otherwise access many network addresses, e.g., websites, that require certain user authentication information to be entered prior to gaining access to the website or to certain privileged data. The user authentication information typically includes, for example, user identification, such as a username, a password and optionally an answer to a particular question that the user has previously answered and that other users would be unlikely to know. Users commonly access many different network addresses with many different usernames and passwords, and it can be very difficult to remember which user authentication information is used to access each of the various network addresses.

Additionally, users of computing devices often initiate many applications programs for accessing data files and browsers for accessing many network addresses. Users typically manually initiate applications for each of the potentially many data files they wish to open, as well as manually initiating multiple browsers for each of the network addresses they wish to access. The process of manually initiating each file, network address and login can be a very cumbersome and time-consuming process, and often leads to frustration of the user.

Most modern operating systems include some ability to automatically launch selected user-level applications upon start-up, that is, when the operating system has booted, loaded necessary drivers, etc. However, such auto-launching at start-up works only with applications that do not require user action such as input of special access information such as the user's log-in name, passwords, etc.

Currently, several products and services are available that are related to various aspects of the above-mentioned problems. For example, one such service is “Yodlee” that is available at the website http://www.yodlee.com. However, Yodlee requires the user to manually initiate access to the Yodlee website, then select each website the user wants to access one at a time from a list of Yodlee supported sites, as well as requiring the user to enter confidential and personal information and storing that information on remote computer servers separate from the user's computer. Many users object to this as invading their privacy and have serious concerns regarding the sharing of their personal information with third parties for marketing and other purposes. Another such product is “Gator” that is available at http://www.gator.com. However, Gator requires the user to manually process more access and login steps than Yodlee, is subject to many of the same privacy concerns, and also may install certain “spyware,” for example, on the user's computing device to track the user's activities and report them to third parties over the network. In the Internet paradigm, spyware is essentially a program that is installed on one's computer to gather information about the user and her activities and relay it to advertisers or other interested third parties without the user's knowledge.

Additionally, U.S. Pat. No. 5,995,965, which is hereby incorporated by reference in its entirety, is related to the above-discussed technology, except that it includes automatic access being initiated by insertion of a smart portable device, such as a smart card.

What is needed is therefore a system and method for automatically initiating access to one or more user-selected network addresses and/or computing application programs simultaneously while requiring minimal input from or actions by the user. This invention provides such a system and method.

### SUMMARY OF THE INVENTION

In one embodiment of the invention, the user need only enter a password or personal identification number (PIN) or biometric information before the automatic launch is commenced. The system and method operate in a secure and private way, and store the user's personal and confidential information only on the user's own computing device, not on a remote server. In addition, the system and method provide the capability to automatically initiate the application programs such that they access specific data files generated by the particular application program. For example, the Microsoft Excel application program can be automatically initiated to open one or more specific Excel data files, and the system and method enable the user to automatically login to one or more personal online accounts (e.g., e-mail accounts, a stock brokerage account) using the same system. Still further, the system and method automatically provide certain network addresses with user authentication data (if necessary), e.g., a username and password, and communicate over a computer network.

One aspect of the invention includes a computerized system for automatically launching one or more application programs comprising a retrieval module for retrieving one or more stored network addresses, an application launch module for launching the one or more application programs to access the one or more stored network addresses, and a login module for automatically logging a user in to a network address by providing user authentication data in the login entry fields without user input. This additionally comprises the system wherein the application launch module further launches one or more application programs to access one or more user data files. This additionally comprises the system wherein the user-selected network address or addresses comprises one or more website Uniform Resource Locators (URLs).

An additional aspect of the invention includes a method of automatically launching one or more application programs comprising retrieving one or more stored network addresses, launching the one or more application programs to access the one or more stored network addresses, and automatically logging a user in to a network address, including providing user authentication data if needed in the login entry fields, without user input. This additionally comprises the method wherein the application launch module further launches one or more application programs to access one or more user data files. This additionally comprises the method wherein the user-selected network address(es) comprises one or more website URLs. This additionally comprises the method wherein the method is executed at system startup. This additionally comprises the method further comprising inputting user authentication information of a user before retrieving the one or more stored network addresses.

### BRIEF DESCRIPTION OF THE DRAWINGS

FIG. 1 is a system diagram of one example of a network and computer device configuration in which the automatic launch and login system according to the invention may operate.

FIG. 2 is a flowchart of the main steps of a preferred operation of the invention.

FIG. 3 illustrates a launch control window.

### DETAILED DESCRIPTION

In broadest terms, this invention involves computer-executable software modules in a user's computer that automatically start (launch) a set of processes, including entry of any required access data such as user names, passwords, etc., and optionally activate data files related to the processes as needed. The processes may be web browsers, application programs, etc. The invention allows for a large range of variation in the type and number of processes that are automatically and (from the perspective of the user, simultaneously) launched; in effect, any process or group of processes that the user could launch manually using conventional input (such as keyboard or voice entries, mouse or touchpad movements, etc.) can be designated for automatic launch using the invention.

In the preferred embodiment of the invention, the system automatically initiates access to one or more user-selected network addresses and/or computing application programs simultaneously while requiring minimal input from or actions by the user. The system and method operate in a secure and private way: The user's personal and confidential information is preferably stored, not on a remote server, but rather only on the user's own computing device, e.g., a personal computer (PC), personal digital assistant (PDA), web-enabled cell phone, set-top box, embedded system, or other wired or wireless computing device.

In addition, the system and method provide the capability to automatically initiate the application program(s) such that they optionally access specific data files generated by the particular application program and optionally provide authentication information to the application program. For example, the Microsoft Excel application program can be automatically initiated to open one or more specific Excel user data files, including any authentication data such as a password if required to access the file(s). Still further, the system and method automatically provide certain network addresses with user authentication data (if required), e.g., username and password, and operate over a computer network, e.g., local area network (LAN), wide area network (WAN), dial-up connection, intranet, the Internet, public or private network, Virtual Private Network (VPN), or any of the multitude of other types of computer networks.

In one embodiment, the system and method provide a client-based solution in which the user's data (including network addresses, e.g., website Uniform Resource Locators, that is, URLs, any access and authentication data required, etc.) are stored with or on the local computing device. In this embodiment, the automatic login feature may be performed by field detection, matching (or downloading of login information from a remote server or even from a locally stored file) and filling of data in the fields, and by automatically sending user entry events, e.g., the “Enter” keystroke or a computer mouse click.

The above embodiments provide many advantageous features and capabilities. For example, one such feature involves greatly enhanced consumer privacy, as personal and confidential data is not stored on a remote server but is instead stored on the user's computing device. An additional advantageous feature involves user control of the user's data, in that the user maintains and controls her own data instead of allowing a third-party organization access to this data.

In an alternative embodiment, the system and method provide a server-based solution in which the user's data (including network addresses, e.g., website URLs and, if required, user login authentication data, if required, such as username and password) are stored on a remote server. This embodiment, while still providing the advantages of automatic initiation and login of one or more network addresses while requiring a minimum of user input, does not provide the privacy advantage of storing the user's personal and confidential information on the user's computing device.

The user authentication data required to access a certain network address will typically comprise a username and password. The authentication data might, however, also include any combination of a digital certificate, digital signature, biometric information, e.g., fingerprint, retinal or other eye scan, voice recognition, or other measurable physical characteristics that can be checked and verified.

In another embodiment, the one or multiple network addresses, which may require user authentication information, may be accessed simultaneously, and the URL(s) and the user's authentication information (again, if required), previously stored either locally on the computing device they are using, or on a remote server, is automatically entered and submitted to the network address(es). Once the login procedure is complete, the user gains access to the network address. The user does not have to manually input any required authentication information for each individual network address, and does not have to manually submit any required authentication information to a server to gain access to the network address. Nor does the user need to provide any manual input such as a keystroke or mouse click to launch and open one or more network addresses.

The system and method according to the invention provide the user with the convenience of being able to access multiple network addresses and other applications simultaneously (that is, without requiring intermediate user action), saving the user the time and effort of having to remember and manually input the specific network addresses, and when required the necessary authentication information to access the network addresses, avoiding the effort of having to manually submit the information for authentication.

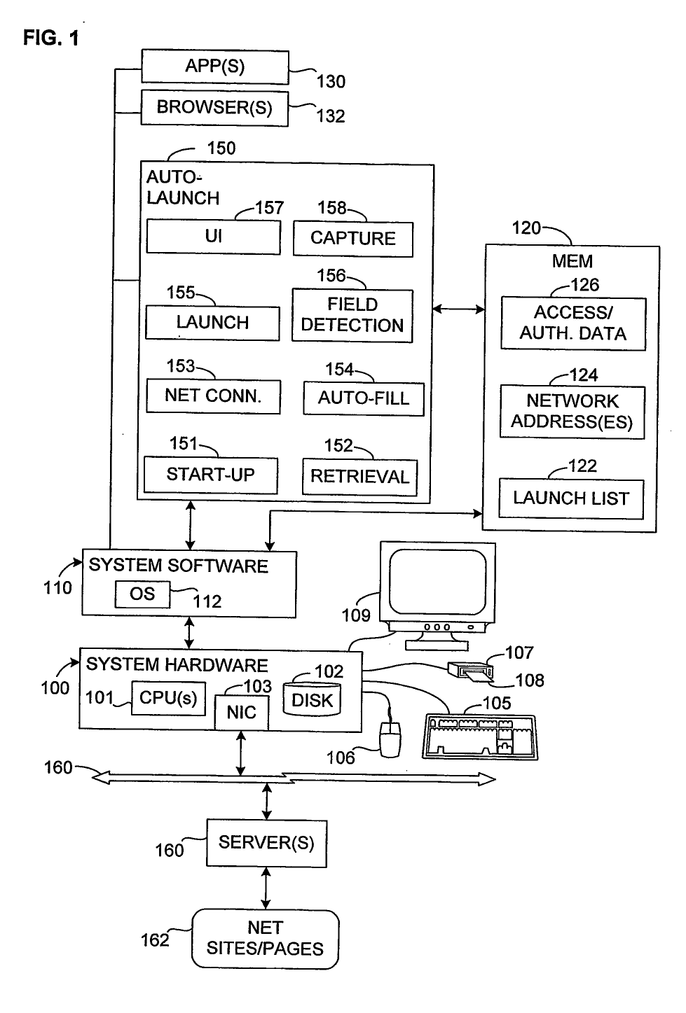

FIG. 1 illustrates the main hardware and software components used to implement the preferred embodiment of the invention. As with most computers, the user's computer includes both system hardware 100 and system software 110. System hardware will include one or more processors 101, some form of non-volatile storage such as one or more disks 102, and one or more devices, such as a network interface card (NIC) 103, to connect the computer to a network 160. Standard input devices such as a keyboard 105 and mouse 106 will normally also be connected in the conventional manner to the system hardware. Where the computer is a device such as a PDA or cellular telephone, the non-volatile storage devices and input devices will of course be those standard in such systems.

Depending on the requirements of any given use of the invention, a reader 107 for a portable data-storage device 108 may also be connected to the user's computer. The portable data-storage device 108 may be completely passive, such as a simple floppy disk, magnetic strip card, etc., or it may be at least partially active, such as a smart card that can include computer-executable code. A display (either visual, audible, or a combination of both) 109 will also be connected to the system hardware; again, this is of course well known.

Memory 120, typically high-speed RAM, is also included in the user's computer. Although normally considered part of the system hardware 100, the memory 120 is shown separately in FIG. 1 to make it easier to understand the function of the invention's software components.

System software 110 will include some form of operating system 112 whose operation and functions are well known. Note that almost all devices that include a processor that executes code will also include some form of system-level kernel that serves as an interface between user-level applications and physical system resources, including the processor itself. For example, even web-enabled cellular phones include a program that accepts user-specified addresses or file names and submits them according to the appropriate protocol to its wireless network. As used in this application, the term “operating system” is to encompass all such system-level, resource-allocating software layers.

The invention is illustrated as being implemented in a single, standard personal computer because this is anticipated to be the most common configuration in which the invention will be included. Any type of computer system may benefit from the invention, however. In this context, a “computer” includes portable devices such as “personal digital assistants” and even modern cellular phones, many of which allow for functions such as web browsing, games, etc.; larger systems such as servers, mainframe computers, etc.; and other systems such as television set-top boxes.

Furthermore, many of the hardware and/or software components shown in FIG. 1 may be distributed or separated. For example, the memory 120 could be remote, in a server contacted via the Internet, or it could be a removable storage medium such as a flash card, a “memory stick,” a smart card, etc.

Any of the thousands of different types and titles of applications 120 may be loaded into the user's computer. Usually, the code and data defining each such application is stored in non-volatile storage (such as the disk 102) until the operating system 112 loads it in whole or in part into memory 120 for execution. For accessing and viewing content via the network 165, one or more browsers 132 will typically be included in the user's computer.

The operating system 112 usually treats a browser like any other application. Nonetheless, the browser 132 is shown separately in FIG. 1 to highlight the invention's unique ability to automatically launch and “log into” both general applications and sites on one or more remote servers 160, which may host not only web content (such as net sites and pages 162), databases, etc., as well as combinations such as customer and member account portals.

The invention comprises an auto-launch (including, as needed, auto-login) utility or application 150, which in turn includes various modules 151-158, some of which are optional, which implement different features of the invention and are described below. All or any of the modules 151-158 may be implemented simply as sub-routines within the larger body of executable code that makes up the auto-launch application 150 as a whole. Skilled programmers will be able to create the modules 151-158 given the description of the functions of each of these modules below. The auto-launch application can be installed in the user's computer in any normal manner such as by loading a CD-ROM disc, through downloading, etc.

During operation of the invention, various types of information will be loaded into the memory 120, either by loading the information from disk or as a result of direct entry by the user. Three memory structures 122,124, 126 are illustrated in FIG. 1: a launch list 122, which includes information identifying which processes are to be automatically launched using the invention; a list 124 of network addresses, for example URLs, that a browser or other network access software can use to access remotely stored content (stored, for example, in one of the servers 160); and a set 126 of access and authorization data, for example, user names, passwords, digital keys, etc. Each of the illustrated memory structures 122, 124, 126 will normally be stored as one or more files on disk, or on some other non-volatile storage medium, and then loaded into memory when the auto-launch application itself is initiated. All of the structures 122, 124, 126 (as well as any other parameters used by the invention) may be stored as a single file as long as this file is structured in a manner known to the module 152 that is to retrieve the stored information.

The type of information used for auto-launch and access will of course depend on what types of applications are to be launched. For example, if no web sites are to be automatically accessed, then there will be no need to retrieve network addresses.

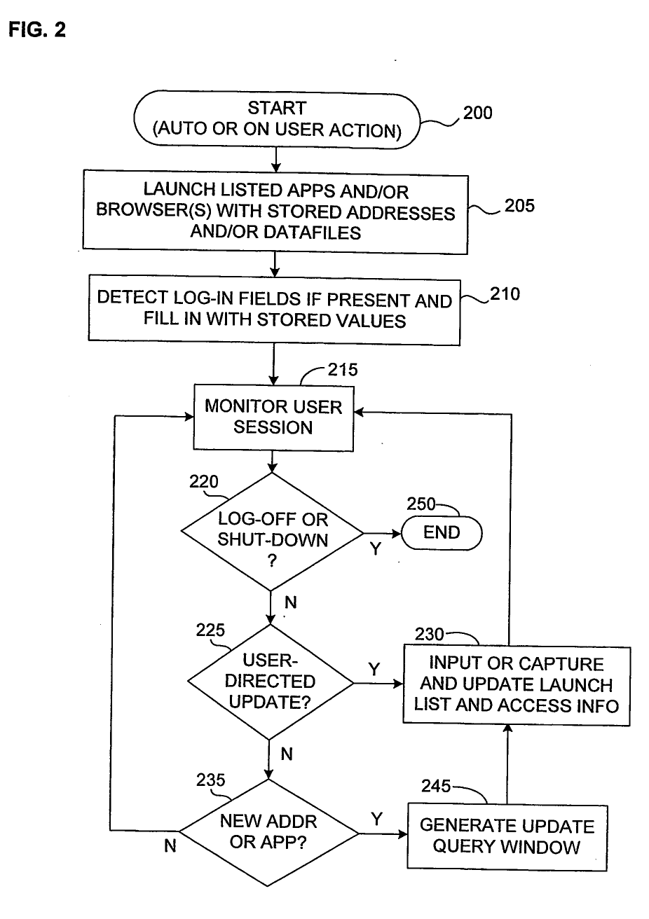

FIG. 2 is a flowchart that shows the main actions of the system according to the invention. The main procedural steps of the invention are:

Step 200: The invention is itself started. This may be done either automatically or manually. For automatic launch, the auto-launch module 150 can be included in the standard start-up list used by the operating system. It would also be possible to include the auto-launch module according to the invention as part of system software itself so that it would load along with other system-level processes during booting. Assuming connection of suitable hardware, auto-launch could also be activated by some other means such as by insertion of a key or smart card, by successful fingerprint or retinal scanning, by voice recognition, etc.

For manual start, an icon could be generated on the user's desktop or system tray, or on a toolbar, or in some list; when the operating system senses user selection of this icon (or program name), then it will start the auto-launch application 150 as it would any other program. Entry of the user's name and/or password (or successful authentication using biometric input, etc.) could also be required to activate the auto-launch application according to the invention. A startup module 151 is therefore preferably included as an interface to the operating system 112 and to interpret the user's manual input to activate the auto-launch program.

Step 205: Once initiated, the auto-launch program needs to know what it is that is to be launched, and how to launch it. The invention may be used to auto-launch any number (including none) of browsers or browser instances, as well as any type and number (again, including none) of other applications. Note that not all auto-launched applications need to be “visible” to the user; rather, applications such as anti-virus or performance-monitoring software that run in the background may also be auto-launched using the invention.

Users will often want to auto-launch one or more non-browser applications, such as a word-processing program, a spreadsheet, etc. Although each such application may be opened “blank,” it will usually be more helpful to the user for the applications to start with some associated data file(s) loaded and “ready.” For example, the user might want his last-opened files to be opened along with the applications. The locators (file names and/or addresses) for any desired data files are therefore preferably maintained along with the respective applications in the launch list 122. Note that the data files to be opened may be remotely stored; in this case, the locators will include the required network address(es).

Similarly, although it would be possible to launch browsers without any automatic web access, the invention is most useful when one or more net sites or web pages are also accessed automatically. The launch list 122 therefore includes the information (usually the entry address) allowing the operating system to initiate the browser(s) to be auto-launched. A set 124 of addresses (such as URLs) is therefore also preferably stored in memory, with any standard data structure used to associate these addresses with the browser. Some browsers, such as Microsoft Internet Explorer have only one remote address “active” at any given time, so that multiple browser instances must be opened if one wants to have multiple web pages available on-screen. Other browsers such as Opera allow multiple web pages (URLs) to be accessed and open within a single browser instance. Both types of browsers may be auto-launched using the invention.

The invention may also be used to auto-launch applications—including browsers—with addresses or other locators to records in a remote data base. Accessing such database records may be done in a manner analogous to accessing specific web pages. The concept of “database” here includes such sites/structures as customer account information and the like, whose associated launch information will typically include both a network address and descriptors identifying at least one remotely stored data file.

In summary, an application that does not presuppose a network connection (such as a word processor) will usually have associated with it one or more data files (such as documents) to be opened; accessing a web site presupposes not only some form of browser or analogous interface software, but also some identifier (for example URL) to the site; access to database records presupposes some form of record or file identifier; etc. In short, each type of process that may be auto-launched using the invention will usually (but not necessarily) also have some other secondary information associated with it in order to recreate the user's preferred work environment. Collectively, the information used to identify the document(s), network address(es), record(s), etc., is referred to as “associated launch data.”

Step 210: In many cases, applications or data files or web pages cannot be launched or opened or accessed without entry of user-specific or other security information. Typically such information will include a user name, a password or other authorization code, a digital signature, or even biometric information such as a fingerprint. For each application, file, page, etc. to be auto-accessed using the invention, the corresponding access/authentication data is preferably stored in memory in ay suitable data structure 126.

Before anything can be accessed via the network 160, there must of course be an open connection to the network. There are two common types of connections, namely, those that require specific user action, such as dial-up modems, and those that are “always on” (automatically initiated by the operating system at the time of system boot) such as DSL, cable connections, etc. Before launching any network-directed application such as a browser, a network connection module 153 within the auto-launch program preferably determines whether the user's computer has an active connection, and what type of connection is involved. This may be done using known software techniques. If user action is required to establish the network connection, the network connection module 153 preferably instructs the user interface 157 (see below) to call up appropriate log-in windows, which are typically generated by the operating system.

Observe that opening a network connection usually involves running a user-level program like any other. For example, most modern operating systems allow a user to define and configure any number of network connections. An icon or at least a name is then associated with each configured connection. Connection configuration may (but need not) include storing access information such as the user's name and password. To initiate the connection, the user clicks on the corresponding icon, chooses the connection from a list, etc., whereupon the operating system initiates the connecting program like any other. Known operating system signals are also available to user-level programs to let them know that there is an active and available network connection, be it manually opened or always on.

When a protected application, web page, etc., is initiated or accessed, it will typically generate (either on its own or through a utility in the operating system) at least one window or screen with log-in data entry fields that the user is to fill in and submit. The programs for establishing network connections generally generate such windows as well in order to first establish the network connection. Of course, always requiring a user to fill in such information would defeat the concept of auto-launch; accordingly, a field detection module 157 is preferably included to detect the presentation of such entry fields (or simply the requirement to enter data) and “auto-fill” module 154 is preferably included to enter and submit the required data automatically. Note that many protected programs (including those that control network connections) already enable users to check a box or otherwise indicate that an entered user name and password should be remembered for future use. The invention takes this one step further—not only is the information automatically “filled in” and submitted, but the application that requires it is also launched without specific user action.

Once all the applications (including browsers) to be opened are identified from the launch list 122, all needed file identifiers (and/or network address(es)) have been retrieved, and all access information (if any) has been properly entered (a step that may be delayed until needed), a launch module 155 is activated, which submits the launch information to the operating system, which in turn loads the selected applications and files, as well as browsers and locators (such as URLs). In other words, all of the steps and all data entry that a user would need to perform to open the desired browsers and other applications are performed automatically by the launch module, which submits the corresponding entries to the operating system through its standard application program interface.

Following whatever protocol it includes for the purpose, the operating system then accesses the network 160 with any associated network address(es) retrieved from memory region 124. Some of the selected web sites (or database or account sites, etc.) may require log-in information. This requirement is expressed to the browser in the form of downloaded html (or other, such as Java) code, and as such is detectable by user-level processes such as a field-detection module 156. The auto-fill module 154 then detects which log-in information is required in each field and submits to the operating system the key (or other input) sequences required to fill in the fields with the correct authentication and/or access data, which is available in memory region 126. Once all such information is submitted for each network location, the state of the user's computer will be as if he had manually activated all desired applications and files, browsers and network sites.

Step 215: At this point, the user may begin a work session, using whatever files and sites have been automatically opened for her. The auto-launch program 150 according to the invention may then simply monitor the user's actions or remain idle until invoked by the user (for example, by clicking on an icon designed for the purpose) in order to change the auto-launch information stored in memory in regions 122, 124, 126.

Step 220: The user may of course choose to end her session with the computer altogether, or to deactivate the invention while continuing other work. Since the auto-launch program is a user-level process, the operating system will halt and unload it like any other process if the user chooses to shut down the computer. Alternatively, the user could specifically close the auto-launch program in any common manner, for example by selecting the program and either clicking on the standard “close” button (usually shown as an “X” at the top right of active windows) or an icon or button displayed specifically for the purpose by the auto-launch program itself. If closed, the program will reach the end 250 of its operation for the current session.

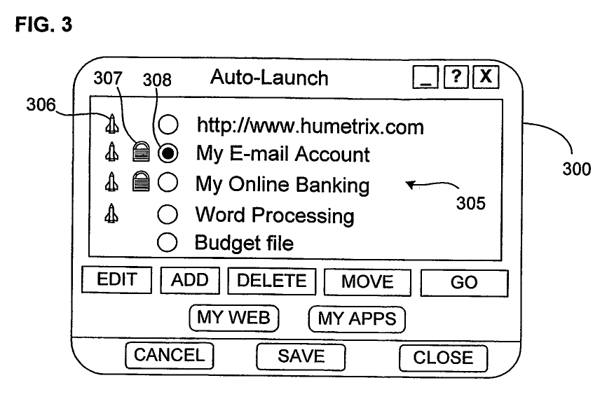

Step 225: Assume that the user wants to update his auto-launch list or parameters. Using any conventional method, such as clicking on an icon, the user may then open the user interface 157 to display a control window. One example of such a control window 300 is illustrated in FIG. 3. As shown, in addition to standard window icons such as those for minimization, closing and calling a help routine, the interface 157 displays a list 305 of all applications, network addresses, etc., that are currently selected for potential auto-launching.

Various icons, buttons, etc., are included to remind the user of the status of each listed process. For example, a symbol 306 such as a small rocket is shown next to each process to indicate that the process is set to be auto-launched using the invention. A lock icon 307 may be included to indicate that the site is also set for auto-login (with, for example, user name and password). Standard radio buttons 308 or similar graphical devices are preferably included next to the listed processes to indicate which is currently selected for editing or other updating. Note that a process may be listed in the control window 300 but not marked for auto-launch; one such process is shown as “Budget File” in FIG. 3. For example, a process previously selected for auto-launch might have been de-selected. If the user wants it removed entirely, he may select it and click on “Delete.”

Updating the auto-launch profile may be done in either (or both) of two ways: manually or through automatic detection:

Assume that the user wants to edit the information, for example, for accessing a web site or for designating which files are to be opened along with a word-processing program. The user edits a process (such as a website or application) record by selecting the name of the process from the list 305, for example, by checking the adjacent radio button or clicking on it with a mouse or similar corsor-control device. In FIG. 3, the user has selected to update information relating to his e-mail account. The user interface 157 may then generate, and cause to be displayed, a typical dialog box, into which the user can make changes to such authorization and access data as the title, URL, username, password, and auto-launch/auto-login status of the selected website.

A listed process may be deleted from the auto-launch list 305 by selecting the process and clicking on a button such as “Delete.” Later confirmation of this decision causes the corresponding entry to be deleted from the launch list 122 as well.

The “Move” button illustrated in FIG. 3 controls a preferred feature in which the user can change the order in which processes are listed and auto-launched. The “Go” button is preferably included to manually open the currently selected process. These two features are found in other contexts and may be implemented using known techniques.

Buttons such as “My Web,” and “My Apps,” are preferably included to make it easier for the user to access features of the invention, although they are optional; buttons for other features may of course also be included depending on the needs of a given application of the invention. Clicking on “My Web” and “My Apps” buttons causes only network sites or non-network based applications, respectively, to be shown in the currently displayed list 305.

Step 230: An advantageous feature included in the preferred embodiment of the invention is its convenience and flexibility when it comes to adding new processes to the auto-launch list. Adding processes may be wholly automated, performed manually, or both.

The preferred embodiment of the invention for adding processes to the auto-launch list 122 uses automatic capture via the module 158. Assume that the user has opened an application (with any desired data files) and/or a web page and assume that the user wants this process environment (program plus any associated open data files and/or network addresses) added to the launch list 122. In other words, assume that a running process is the currently active, displayed process, along with whatever data file(s) are also currently being worked on. For example, the user may currently be working with a word-processing program with three open documents. The program will then be the active process and the documents will be the associated launch information.

Note that the data defining the environment will be accessible to user-level applications using known commands and queries to the operating system. According to the invention, the user may add the process and its associated launch information to the auto-launch list this simply by clicking on the “Add” button (or some analogous icon). The invention thus provides (but does not require) a “one-click” process-addition feature; it would be possible, however, to require the user to confirm desired addition via an additional window. The capture module then extracts all parameters needed to open the process (usually, executable file name and location) and currently associated data files (usually by file name) from the current status of the running process. If available, the module may also capture whatever log-in information was required to open the process. If not readily available, the capture module could extract this information if other modules, such as the field detection module 156, are programmed to track user input to identify manual input of log-in information.

The process currently in active use is then preferably added to the currently displayed list 305 so that the user will have an opportunity to change her mind before the extracted parameters are entered into the data structures 122, 124, 126 for use the next time the auto-launch program according to the invention is activated. Alternatively, or in addition, the user interface 157 could display for the user a confirmation window that asks the user to confirm whether the current process should be listed in the control window 300 and whether it should be auto-launched when the auto-launch program 150 itself is next launched. Once accepted, the capture module 158 enters the captured data into the appropriate data structures 122, 124, 126 in memory.

The user may leave the information extracted by auto-capture unchanged, or he may edit it. For example, the user might want to change the name of a current website record in a “Title” field and assign a name that allows him to distinguish it more easily from the others in the event of multiple accounts.

It would also be possible to implement manual process addition. In this case, when the user clicks on the Add button, a conventional window could be opened to allow the user to manually select programs for inclusion in the auto-launch list 122. Standard operating systems, for example, maintain up-to-date lists of user-selectable programs (for example, the Microsoft Windows “All Programs” selection on the “Start” menu). The user could then select programs, and data files of an appropriate type, using conventional file browsing and “attach” commands. Note that the preferred automatic capture feature described above (in which the current environment is captured) avoids the inconvenience and much higher probability of error of manual selection: For example, open data files in a spreadsheet program are guaranteed to have a compatible file type.

Of course, at any time the user may discard entered changes by clicking on a “Cancel” button. Clicking on “Save,” however, directs the capture module to enter the changes into memory. By clicking on “Close,” the user can close the displayed auto-launch control window and continue working with the currently active process.

Steps 235 and 240: The preferred embodiment of the invention does not require specific user action—such as opening the control window 300—to initiate auto-launch process capture. Assume, for example, that the user logs in to a password-protected web site (or application) for the first time (tracked in any known manner), or to a site not currently included in the launch list 122. This may be detected in any known manner.

If the newly activated process is new to the auto-launch application 150 according to the invention, the application (via the interface 157) can then generate a window giving the user the opportunity, by clicking on appropriate buttons or checking conventional boxes, to add this new process to the process list 305 and/or the launch list 122. Parameter input and capture may be done as before (see Step 230).

The flowchart shown in FIG. 2 is not exhaustive; rather, other steps may be included in the operation of the auto-launch utility according to the invention. For example, the utility preferably includes certain error-handling mechanisms. For example, assume that the auto-launch application 150 is itself launched by insertion of a smart card. It is possible that a file path stored on the card is no longer valid, or, indeed, that a listed application is no longer resident on the computer in which the card is inserted. Any known mechanism is therefore included within the auto-launch application 150 to notify the user whenever a process that is listed for auto-launch cannot be launched. For example, in addition to, or instead of, a warning window, the auto-launch application 150 could give a special indication, such as distinctive shading in the control window 300, to any un-launchable process, along with some message indicating the problem.

As mentioned above, not all modules and data structures used in the auto-launch procedure according to the invention need to reside on the same computer. For example, it would be possible to maintain the launch list 122, as well as the sets 124 and 126 of network addresses and access and authorization data on a secure, remote server such as one under the control of a company's system administrator, or a service the user subscribes to.

1. A method for launching processes in a computer that has an operating system, comprising:
storing a launch list of initiation data for at least one process to be launched;
for each process, storing any access and authentication information required to initiate the process, as well as associated launch data identifying secondary information associated with any of the processes to be launched;
upon sensing a launch event:
automatically retrieving initiation data for each process in the launch list, as well as the associated launch data for each process; and
automatically initiating execution of each process in the launch list and automatically retrieving and associating with each initiated process the corresponding secondary information.

2. A method as in claim 1, in which at least one process to be launched involves access to at least one remote site, further comprising automatically accessing the remote site over a network, a network address for each remote site comprising the secondary information of the process.

3. A method as in claims 1 or 2, further comprising:
automatically detecting identifying information of a currently active process and its current secondary information; and
upon user confirmation, automatically storing access information and the current secondary information for subsequent automatic launch upon sensing the launch event.

4. A method as in any of claims 1-3, further comprising:
automatically detecting identifying information of a process currently being launched manually by a user;
upon user confirmation, automatically storing the identifying information of the process currently being launched manually by a user as access information for subsequent automatic launch upon sensing the launch event.

5. A method as in any of the claims 14, in which:
the secondary information includes access and authentication information such as a password; and
the step of automatically initiating execution of each process includes automatically submitting the secondary information.

6. A method as in claim 1, comprising automatically launching two or more processes simultaneously, that is, without requiring intermediate user action.

7. A method as in claim 6, comprising automatically and simultaneously launching both processes that access network content and processes that access only locally stored files.

8. A system for launching processes in a computer that has system hardware (100), system software (110), and a memory (120), comprising:
a launch list (122) of initiation data for at least one process (130; 132) to be launched;
a stored set (126) of any access and authentication information required to initiate the process, as well as associated launch data set identifying secondary information associated with any of the processes to be launched;
an auto-launch software module (150) comprising computer-executable code that, upon sensing a launch event:
automatically retrieves initiation data for each process in the launch list, as well as the associated launch data for each process; and
automatically initiates execution of each process in the launch list (122) and automatically retrieves and associates with each initiated process the corresponding secondary information.

9. A system as in claim 8, in which:
at least one process to be launched involves access to at least one remote site (162);
the system hardware includes a network-connection device (103) that forms an interface between the computer and a network (160);
the memory (120) includes a list (124) of network addresses;
the auto-launch software module (150) includes computer-executable code for automatically accessing the remote site over the network (160), a network address for each remote site comprising the secondary information of the process.

10. A system as in claims 8 or 9, in which the auto-launch software module (150) includes further computer-executable:
for automatically detecting identifying information of a currently active process and its current secondary information; and
upon user confirmation, for automatically storing in the memory (120) access information and the current secondary information for subsequent automatic launch upon sensing the launch event.

11. A system as in any of claims 8-10, further comprising:
at least one input device (105, 106, 107, 108) connected to the system hardware (100) for manual input by a user;
the auto-launch software module (150) includes further computer-executable code
that automatically detects identifying information of a process currently being launched manually by a user, and
upon user confirmation, that automatically stores in the memory (120) the identifying information of the process currently being launched manually by the user as access information for subsequent automatic launch upon sensing the launch event.

12. A system as in claim 8, in which the auto-launch software module (150) automatically launches two or more processes simultaneously, that is, without requiring intermediate user action.

13. A system as in claim 8, in which the auto-launch software module (150) automatically launches both processes that access content over a network (160) and processes that access only locally stored files.
